(19) United States
(12) Patent Application Publication
(10) Pub. No.: US 2010/0007994 A1
(43) Pub. Date: Jan. 14, 2010

(54) RECORDING DISK DRIVE AND LATCH DEVICE

(75) Inventor: Yoshiaki Hosokawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/563,674

(22) Filed: Sep. 21, 2009

Related U.S. Application Data
(63) Continuation of application No. PCT/JP2007/058424, filed on Apr. 18, 2007.

(51) Int. Cl. G11B 5/54

(52) U.S. Cl. 360/256.2; G9B/5.181

(57) ABSTRACT

According to one embodiment, a recording disk drive includes a head actuator assembly, a voice coil motor, a housing, a step, a latch lever, a latch member, and first and second contact pieces. The head actuator assembly supports a head slider. The housing houses defines a flat surface for receiving the voice coil motor. The step is connected to one end of the flat surface and defines a stepped surface expanding parallel to the flat surface. The latch lever is rotatably supported by a first shaft. The latch member is rotatably supported by a second shaft, and rotate between a first posture and a second posture. The first and second contact pieces on the latch member cause the latch member to rotate about the second shaft toward the first posture by contact with the latch lever rotating in first and second directions, respectively.

### CROSS-REFERENCE TO RELATED APPLICATIONS

This application is a continuation of PCT international application Ser. No. PCT/JP2007/058424 filed on Apr. 18, 2007 which designates the United States, incorporated herein by reference.

### BACKGROUND

1. Field

One embodiment of the invention relates to a recording disk drive, and more particularly, to a latch device that is built in a recording disk drive.

2. Description of the Related Art

A head actuator assembly is built in a case of a hard disk drive (HDD). A head actuator assembly is rotated about a spindle, and is connected to a voice coil motor. A head slider is supported by the end of the head actuator assembly. A magnetic head is mounted on the head slider.

A latch device is associated with the head actuator assembly. The latch device comprises a latch lever that is swung about a first shaft in accordance with an impact applied to the HDD, and a latch member that is swung about a second shaft while interlocking with the swing of the latch lever. When the latch lever is swung, the latch member is caught by the head actuator assembly. Accordingly, the swing of the head actuator assembly is regulated. The head actuator assembly is held on a lamp member. The head slider is held outside a magnetic disk. Reference may be had to, for example, Japanese Patent Application Publication (KOKAI) No. 2002-313040.

The latch lever and the latch member are arranged between the inner wall surface of a case and the voice coil motor. The dimension of the case is determined by standards. If the size of the case is reduced and the size of the latch lever or the latch member is not reduced, the voice coil motor is close to the magnetic disk. For this reason, the degree of freedom in the design of the latch lever or the latch member is decreased. In contrast, if the degree of freedom in the design of the latch lever or the latch member takes higher priority, the voice coil motor needs to be downsized.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view of a hard disk drive (HDD) as an example of a recording disk drive according to an embodiment of the invention;

FIG. 2 is an exemplary front view of the hard disk drive in the embodiment;

FIG. 3 is an exemplary plan view schematically illustrating the inner structure of the hard disk drive in the embodiment;

FIG. 4 is an exemplary partial enlarged plan view of a latch device in the embodiment;

FIG. 5 is another exemplary partial enlarged plan view of the latch device in the embodiment;

FIG. 6 is an exemplary partial enlarged perspective view of the latch member in the embodiment;

FIG. 7 is an exemplary partial enlarged plan view of a latch lever that simultaneously comes in contact with first and second contact pieces in the embodiment;

FIG. 8 is an exemplary partial enlarged plan view of the latch lever rotating in a first rotational direction in the embodiment;

FIG. 9 is an exemplary partial enlarged plan view of the latch lever rotating in a second rotational direction in the embodiment;

FIG. 10 is an exemplary enlarged partial cross-sectional view taken along a line 10-10 of FIG. 3 in the embodiment;

FIG. 11 is an exemplary side view of a step in the embodiment; and

FIG. 12 is an exemplary partial enlarged plan view of the latch lever that faces a stepped surface in the embodiment.

### DETAILED DESCRIPTION

Various embodiments according to the invention will be described hereinafter with reference to the accompanying drawings. In general, according to one embodiment of the invention, a recording disk drive comprises a head actuator assembly, a voice coil motor, a housing, a step, a latch lever, a latch member, and first and second contact pieces. The head actuator assembly is configured to support a head slider, and follow a predetermined moving path when separated from a lamp member by being swung about a spindle. The voice coil motor is configured to be connected to the head actuator assembly. The housing is configured to house at least the head slider, the head actuator assembly, and the voice coil motor, and define a flat surface for receiving the voice coil motor. The step is configured to be connected to one end of the flat surface and define a stepped surface. The stepped surface expands parallel to the flat surface at a predetermined height from the flat surface. The latch lever is configured to be rotatably supported by a first shaft. At least part of the latch lever faces the stepped surface. The latch member is configured to be rotatably supported by a second shaft distant from the first shaft by a first distance, and rotate between a first posture where the latch member enters the moving path of the head actuator assembly and a second posture where the latch member retreats from the moving path of the head actuator assembly. The first contact piece is formed on the latch member at a position distant from the first shaft by a second distance shorter than the first distance. The first contact piece is configured to cause the latch member to rotate about the second shaft toward the first posture by contact with the latch lever rotating about the first shaft in a first direction. The second contact piece is formed on the latch member at a position distant from the first shaft by a third distance longer than the first distance. The second contact piece is configured to cause the latch member to rotate about the second shaft toward the first posture by contact with the latch lever rotating about the first shaft in a second direction, and be received by the step in the first posture of the latch member.

According to another embodiment of the invention, a latch device comprises a base, a step, a latch lever, a latch member, a first contact piece, and a second contact piece. The base is configured to house at least a head slider, a head actuator assembly, and a voice coil motor, and define a flat surface for receiving the voice coil motor. The step is configured to be connected to one end of the flat surface and define a stepped surface. The stepped surface expands parallel to the flat surface at a predetermined height from the flat surface. The latch lever is configured to be rotatably supported by a first shaft. At least part of the latch lever faces the stepped surface. The latch member is configured to be rotatably supported by a second shaft distant from the first shaft by a first distance, and rotate between a first posture where the latch member enters a moving path of the head actuator assembly and a second posture where the latch member retreats from the moving path of the head actuator assembly. The first contact piece is formed on the latch member at a position distant from the first shaft by a second distance shorter than the first distance. The first contact piece is configured to cause the latch member to rotate about the second shaft toward the first posture by contact with the latch lever rotating about the first shaft in a first direction. The second contact piece is formed on the latch member at a position distant from the first shaft by a third distance longer than the first distance. The second contact piece is configured to cause the latch member to rotate about the second shaft toward the first posture by contact with the latch lever rotating about the first shaft in a second direction, and be received by the step in the first posture of the latch member.

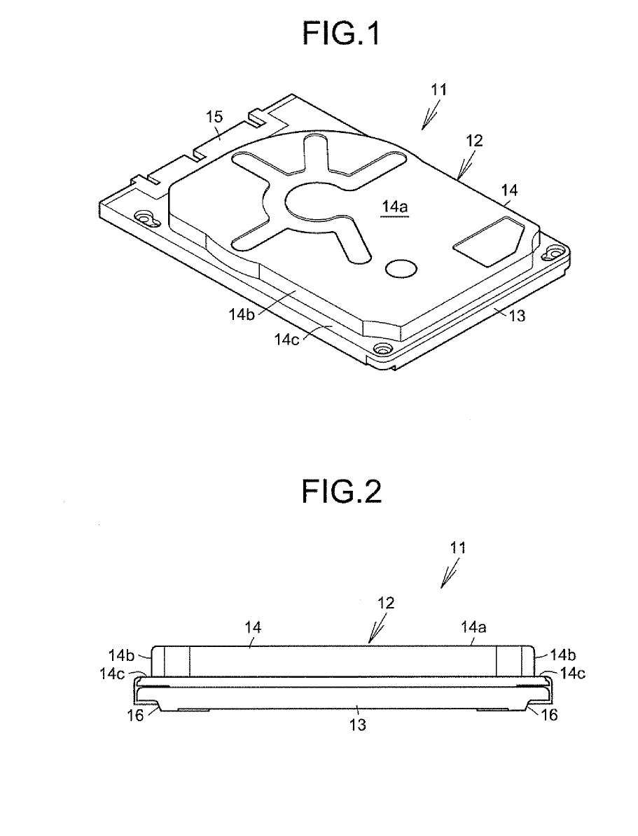

FIG. 1 schematically illustrates the appearance of a hard disk drive (HDD) 11 as a specific example of a recording disk drive according to an embodiment of the invention. A housing 12 of the HDD 11 is provided with a base 13 that expands along a reference plane. The outline of the base 13 is defined by a rectangular shape. The base 13 is formed of, for example, one plate. For example, drawing may be used to form the base 13. A metal plate such as an aluminum plate may be used as the plate. Alternatively, casting and the like may be used to form the base 13. The base 13 may be formed to have a uniform thickness.

A cover 14 is fitted to the base 13. The cover 14 comprises a ceiling board 14a that expands parallel to the reference plane. A receiving space is provided between the ceiling board 14a and the base 13. The receiving space is continuously surrounded by a surrounding wall 14b. An upper end of the surrounding wall 14b is connected to the periphery of the ceiling board 14a.

The cover 14 comprises a flat portion 14c that overlaps a surface of the base 13 around the surrounding wall 14b. The flat portion 14c continuously surrounds the receiving space. A lower end of the surrounding wall 14b is connected to the flat portion 14c. The cover 14 may be formed of, for example, one plate by drawing. A metal plate such as an aluminum plate may be used as the plate.

A connector 15 is formed at an end of the base 13 defined by a short side of a rectangle. A printed circuit board (not illustrated) is mounted on the back of the base 13. The connector 15 is mounted on the printed circuit board.

Referring to FIG. 2 together, steps 16 are formed at side ends of the base 13 that are defined by two long sides of a rectangle. The steps 16 extend along the long sides from one short side toward the other short side. As described below, the steps 16 form steps at the base 13 along the receiving space. The housing 12 of the HDD 11 is formed to have the dimension and shape corresponding to PC card standard Type III. However, the dimension and shape may be changed according to the intended use.

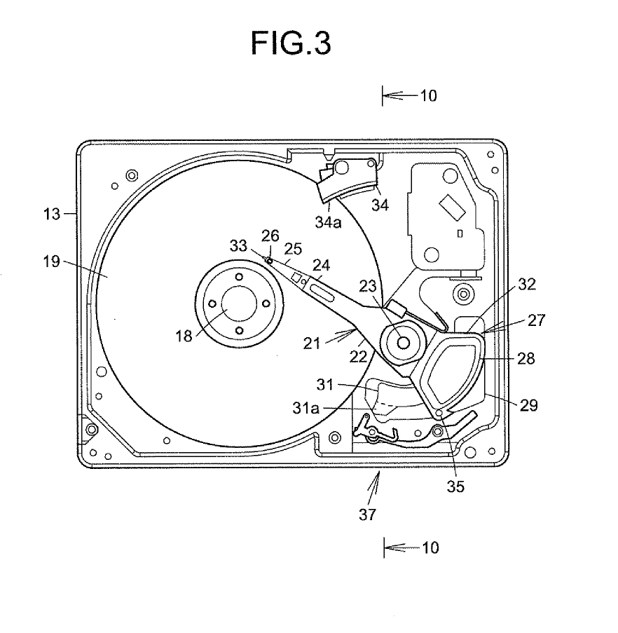

As illustrated in FIG. 3, a spindle motor 18 is mounted on the surface of the base 13. One or more magnetic disks 19 are fitted to the rotary shaft of the spindle motor 18 as recording media. The spindle motor 18 and the magnetic disks 19 are received in the receiving space. The spindle motor 18 may rotate the magnetic disks 19 at high speed such as, for example, 4200 rpm, 3600 rpm, or the like. For example, a 1.8-inch or 1.0-inch magnetic disk may be used as the magnetic disk 19.

A carriage 21 is mounted on the surface of the base 13. The carriage 21 comprises a carriage block 22. The carriage block 22 is rotatably connected to a spindle 23 that extends in the vertical direction. A plurality of carriage arms 24, which extends from the spindle 23 in the horizontal direction, is provided on the carriage block 22. For example, the carriage block 22 may be made of aluminum by extrusion molding.

Attached to the end of each of the carriage arms 24 is a head suspension 25. The head suspension 25 extends forward from the end of the carriage arm 24. A flexure is attached to the head suspension 25. A flying head slider 26 is mounted on the surface of the flexure at the end of the head suspension 25. A so-called gimbal spring is provided at the flexure. The posture of the flying head slider 26 may be changed relative to the head suspension 25 by the action of the gimbal spring.

A magnetic head, i.e., an electromagnetic transducer device (not illustrated) is mounted on the flying head slider 26. The electromagnetic transducer device comprises a writing element and a reading element. A so-called thin-film magnetic head is used as the writing element. The thin-film magnetic head generates a magnetic field by the action of the thin-film coil pattern. Information is written in the magnetic disk 19 by the action of the magnetic field. Meanwhile, a giant magnetoresistive (GMR) element or a tunnel junction magnetoresistive (TMR) element is used as the reading element. In the GMR element or the TMR element, the resistance change of a spin valve film or a tunnel junction film is caused according to the direction of the magnetic field applied from the magnetic disk 19. Information is read from the magnetic disk 19 on the basis of the resistance change.

If an air flow is generated on the surface of the magnetic disk 19 due to the rotation of the magnetic disk 19, positive pressure, i.e., buoyancy, and negative pressure act on the flying head slider 26 by the action of the air flow. If the buoyancy, the negative pressure, and a pressing force of the head suspension 25 are in balance, the flying head slider 26 can keep floating with relatively high stiffness during the rotation of the magnetic disk 19.

If the carriage 21 rotates about the spindle 23 while the flying head slider 26 is floating, the flying head slider 26 can move along the radial line of the magnetic disk 19. As a result, the electromagnetic transducer device mounted on the flying head slider 26 can traverse a data zone between the innermost recording track and the outermost recording track. In this manner, the electromagnetic transducer device on the flying head slider 26 is positioned on a target recording track.

For example, a power source such as a voice coil motor (VCM) 27 is connected to the carriage block 22. The VCM 27 comprises a voice coil 28 that is connected to the carriage block 22, and an upper yoke (not illustrated) and a lower yoke 29 that are fixed to the base 13. A permanent magnet 31 is fixed to the upper yoke and the lower yoke 29. A magnetic field is generated between the upper yoke and the lower yoke 29 by the action of the permanent magnet 31. In the magnetic field, magnetic flux passes in one direction between the upper yoke and the lower yoke 29.

When the voice coil 28 is established, a coil support 32 is connected to the carriage block 22. The coil support 32 may be integrally formed with the carriage block 22. The coil support 32 extends from the spindle 23 in the horizontal direction. The voice coil 28 is wound on the coil support 32. In this manner, the voice coil 28 is disposed in the magnetic field between the upper yoke and the lower yoke 29. When a magnetic field is generated on the voice coil 28 in accordance with the supply of current, the rotation of the carriage block 22 about the spindle 23 is caused. As a result, the carriage arm 24 and the head suspension 25 may be swung by the rotation of the carriage block 22. The carriage 21, the flying head slider 26, and the VCM 27 are received in the receiving space.

A load member that extends forward from the end of the head suspension 25, i.e., a load tab 33 is fixed to the end of the head suspension 25. The load tab 33 may move in the radial direction of the magnetic disk 19 by the swing of the carriage arm 24. A lamp member 34 is disposed on a moving path of the load tab 33 outside the magnetic disk 19. The lamp member 34 is fixed to the base 13. The load tab 33 is received by the lamp member 34. In this case, the load tab 33, the head suspension 25, and the carriage 21 serves as a head actuator assembly.

A lamp 34a, which extends along the moving path of the load tab 33, is formed in the lamp member 34. As becoming distant from the center of the magnetic disk 19, the lamp 34a becomes distant from a virtual plane including the surface of the magnetic disk 19. Accordingly, when the carriage arm 24 is swung about the spindle 23 and becomes distant from the rotary shaft of the magnetic disk 19, the load tab 33 ascends the lamp 34a. Accordingly, the flying head slider 26 is separated from the surface of the magnetic disk 19. The flying head slider 26 is held outside the magnetic disk 19. In contrast, when the carriage arm 24 is swung about the spindle 23 toward the rotary shaft of the magnetic disk 19, the load tab 33 descends the lamp 34a. The flying head slider 26 floats from the surface of the rotating magnetic disk 19. The lamp member 34 and the load tab 33 together form a so-called load/unload mechanism. The lamp member 34 may be molded using, for example, a hard plastic material.

A holding mechanism is combined with the carriage 21. The holding mechanism is provided with a metal piece 35 embedded in the coil support 32. When the carriage block 22 rotates about the spindle 23, the metal piece 35 follows a predetermined moving path. The moving path is formed around the spindle 23 outside the outline of the permanent magnet 31 provided on the lower yoke 29. However, an ampullar portion 31a, which protrudes toward the moving path, is provided on the permanent magnet 31. When the load tab 33 becomes distant from the magnetic disk 19 on the lamp member 34 as far as possible, the metal piece 35 provided on the coil support 32 faces the ampullar portion 31a. The metal piece 35 is attracted to the ampullar portion 31a by the action of a magnetic force. In this manner, the carriage 21 is held in pause (in pause posture or state).

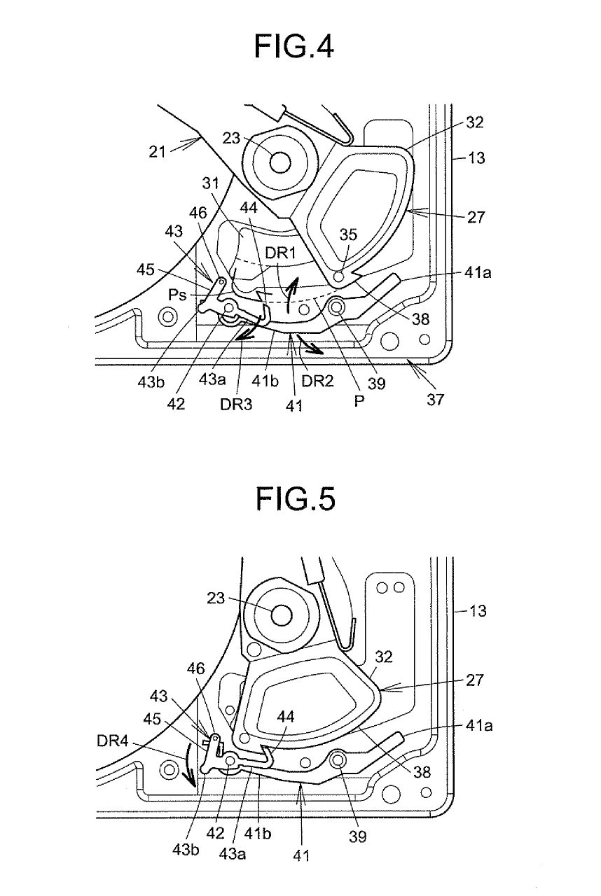

A latch device 37 is further combined with the carriage 21. As illustrated in FIG. 4, the latch device 37 comprises a protruding piece 38 that is formed at the coil support 32 and protrudes in a centrifugal direction around the spindle 23. The protruding piece 38 forms a hook at the outer end of the coil support 32. The protruding piece 38 may be integrally formed with the coil support 32. The protruding piece 38 moves along a predetermined moving path P, which is formed on a virtual circle around the spindle 23, by the swing of the carriage 21, i.e., the coil support 32. When the pause posture of the carriage 21 is established, the protruding piece 38 is positioned at the pause position Ps at one end of the moving path P.

The latch device 37 further comprises a latch lever 41 that is rotatably supported by a first support shaft 39. The first support shaft 39 erects on the surface of the base 13. The first support shaft 39 may be integrally formed with the base 13. The latch lever 41 comprises a weight 41a that extends from the first support shaft 39 in a first direction, and an operating element 41b that extends from the first support shaft 39 in a second direction opposite to the first direction. Acceleration is applied to the weight 41a in accordance with an impact applied to the HDD 11. The latch lever 41 is swung by the acceleration about the first support shaft 39 in a first rotational direction DR1 or a second rotational direction DR2 in accordance with the direction of the impact. The latch lever 41 may be made of, for example, aluminum.

The latch device 37 further comprises a latch member 43 that is rotatably supported by a second support shaft 42. Likewise, the second support shaft 42 erects on the surface of the base 13. The second support shaft 42 may be integrally formed with the base 13. The latch member 43 comprises a first arm 43a that extends from the second support shaft 42 toward the first support shaft 39 in the first direction, i.e., a swing piece, and a second arm 43b that extends from the second support shaft 42 in the second direction opposite to the first direction. A hook 44, which extends toward the coil support 32, is formed at the end of the first arm 43a. Likewise, a branch 45, which extends toward the coil support 32, is formed at the end of the second arm 43b. A metal piece 46 is embedded in the end of the branch 45. The latch member 43 may be made of, for example, a resin material.

The metal piece 46 provided on the branch 45 is attracted to the permanent magnet 31 of the VCM 27. As a result, the latch member 43 rotates in a third rotational direction DR3 as much as possible. In this case, the hook 44 provided on the first arm 43a retreats from the moving path P of the protruding piece 38. Waiting posture or state of the latch member 43 is established. In contrast, when the latch member 43 rotates from the waiting posture in a fourth rotational direction DR4 opposite to the third rotational direction DR3 as illustrated in FIG. 5, the hook 44 provided on the first arm 43a enters the moving path P of the protruding piece 38. In this case, if the protruding piece 38 goes out of the pause position Ps, the protruding piece 38 is caught by the hook 44. The rotation of the carriage 21 is regulated in this manner. The load tab 33 is held on the lamp member 34. The flying head slider 26 is held outside the magnetic disk 19.

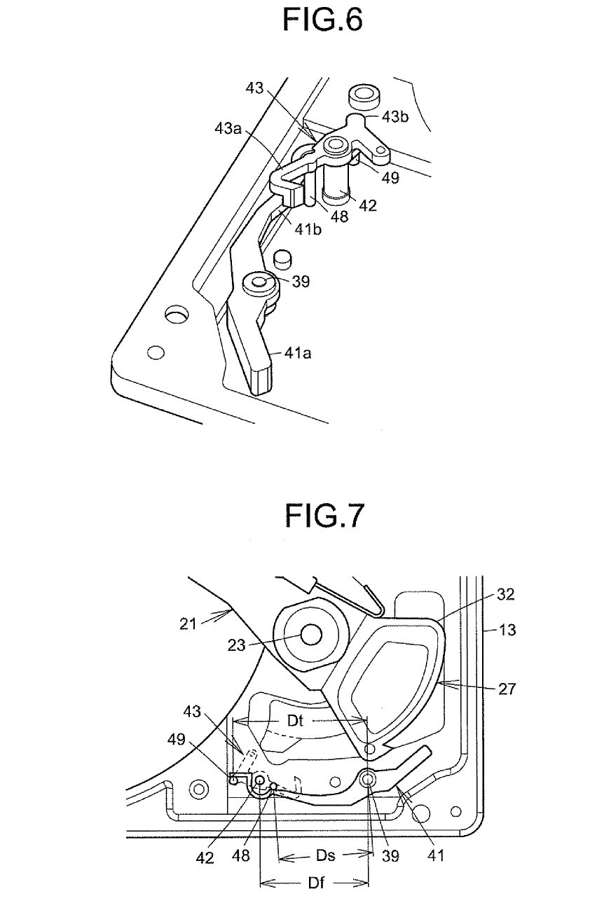

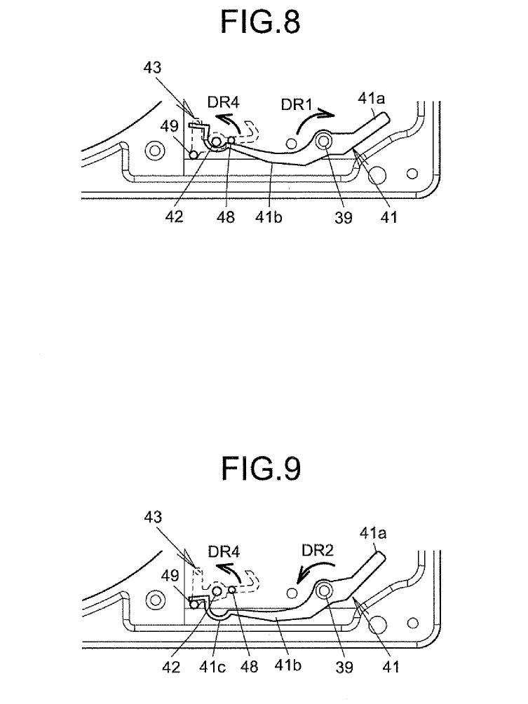

As illustrated in FIG. 6, a rod-shaped first contact piece 48 is formed at the first arm 43a of the latch member 43. The first contact piece 48 extends parallel to the second support shaft 42 from the first arm 43a toward the surface of the base 13. Likewise, a rod-shaped second contact piece 49 is formed at the second arm 43b of the latch member 43. The second contact piece 49 extends parallel to the second support shaft 42 from the second arm 43b toward the surface of the base 13. As illustrated in FIG. 7, the first contact piece 48 is disposed at a position distant from the first support shaft 39 by a second distance Ds shorter than a first distance Df between the first and second support shafts 39 and 42. The second contact piece 49 is disposed at a position distant from the first support shaft 39 by a third distance Dt longer than the first distance Df. The latch lever 41 is disposed between the first and second contact pieces 48 and 49. When the waiting posture of the latch member 43 is established, the latch lever 41 simultaneously comes in contact with the first and second contact pieces 48 and 49. When the latch lever 41 is swung about the first support shaft 39 in the first rotational direction DR1 as illustrated in FIG. 8, a driving force is transmitted from the latch lever 41 to the first contact piece 48. As a result, the latch member 43 rotates about the second support shaft 42 from the waiting posture in the fourth rotational direction DR4. The hook 44 enters the moving path P of the protruding piece 38. Operating posture or state of the latch member 43 is established. In contrast, when the latch lever 41 is swung about the first support shaft 39 in the second rotational direction DR2 as illustrated in FIG. 9, a driving force is transmitted from the latch lever 41 to the second contact piece 49. As a result, the latch member 43 rotates about the second support shaft 42 from the waiting posture in the fourth rotational direction DR4. Likewise, the hook 44 enters the moving path P of the protruding piece 38. In this case, a curved portion 41c, which goes round the second support shaft 42, is provided at the latch lever 41. When the latch lever is swung about the first support shaft 39, the latch lever 41 does not collide with the second support shaft 42 due to the curved portion 41c.

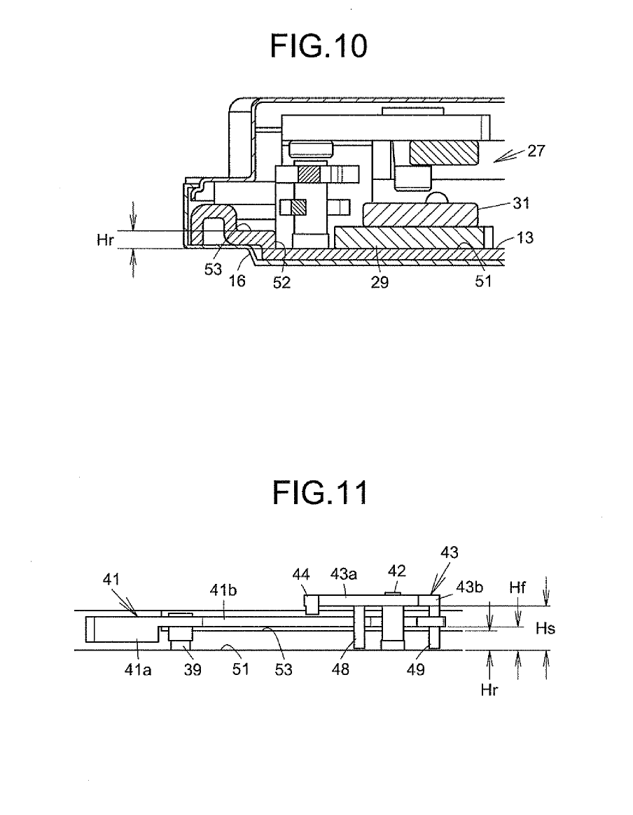

As illustrated in FIG. 10, a flat surface 51, which takes the lower yoke 29 of the VCM 27, is defined on the base 13. A step 52 is connected to one end of the flat surface 51. The step 52 reflects the shape of the step 16. The step 52 defines a stepped surface 53 that expands parallel to the flat surface 51 at a predetermined reference height Hr from the flat surface 51. The first and second support shafts 39 and 42 rise from the flat surface 51 between the step 52 and the lower yoke 29.

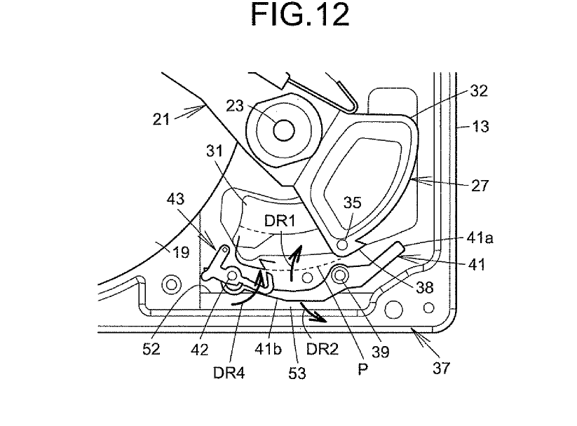

As illustrated in FIG. 11, the operating element 41b of the latch lever 41 expands at a first height Hf that is higher than the reference height Hr. The first and second arms 43a and 43b of the latch member 43 expand at a second height Hs that is higher than the first height Hf. When the latch lever 41 is swung, the operating element 41b is displaced in a space formed on the stepped surface 53. The first and second contact pieces 48 and 49 extend toward the surface of the base 13 to the height that is lower than the reference height Hr. As a result, when the latch member 43 rotates about the second support shaft 42 in the fourth rotational direction DR4 as much as possible, the second contact piece 49 is received by the step 52. Accordingly, the operating posture of the latch member 43 may be accurately set.

In this case, the weight 41a of the latch lever 41 may extend toward the surface of the base 13 from the first height Hf. As a result, sufficient weight may be secured for the weight 41a. The first and second heights Hf and Hs may be defined from the flat surface 51. As apparent from FIG. 11, the hook 44 has a thickness larger than the thickness of the first arm 43a in the axial direction of the second support shaft 42. Accordingly, the hook 44 may be reliably engaged with the protruding piece 38.

When the latch lever 41 is swung, the operating element 41b of the latch lever 41 faces the stepped surface 53 as illustrated in FIG. 12. The operating element 41b is displaced in a space formed on the stepped surface 53. Accordingly, the step 52 secures a space where the operating element 41b moves. It may be possible to avoid the displacement of the VCM 27 toward the magnetic disk 19. The reduction in the size of the VCM 27 may be avoided. A sufficient driving force is secured by the VCM 27. Sufficient responsivity is secured in the carriage 21. The degree of freedom in the design of the latch lever 41 or the latch member 43 is secured.

As described above, according to an embodiment of the invention, when the latch lever rotates about the first shaft in the first direction, the latch lever comes in contact with the first contact piece. A driving force is transmitted from the latch lever to the first contact piece. As a result, the latch member rotates about the second shaft toward the first posture. The latch member enters the moving path of the head actuator assembly in the first posture. Accordingly, the rotation of the head actuator assembly is regulated. The head actuator assembly is held on the lamp member. On the other hand, when the latch lever rotates about the first shaft in the second direction, the latch lever comes in contact with the second contact piece. A driving force is transmitted from the latch lever to the second contact piece. As a result, the latch member rotates about the second shaft toward the first posture. Likewise, the head actuator assembly is held on the lamp member in this manner. Even if an impact is applied to the recording disk drive from the outside, the head slider can be reliably held outside a recording medium. In addition, a space is secured on the stepped surface in the recording disk drive. The latch lever can move in this space. The displacement of the voice coil motor can be avoided. The downsizing of the voice coil motor can be avoided, and a sufficient driving force can be ensured by the voice coil motor. Sufficient responsivity can be ensured in the head actuator assembly. The degree of freedom in the design of the latch lever or the latch member can be secured. In addition, the second contact piece is received by the step in the first posture of the latch member. As a result, the first posture of the latch member can be accurately set.

In the recording disk drive, the latch lever may expand at a first height higher than a predetermined height from the flat surface. The latch member may expand at a second height higher than the first height from the flat surface. In this manner, the latch lever may be reliably arranged in a space formed on the stepped surface. In this case, the first and second contact pieces may extend to the height lower than the predetermined height from the second height.

Moreover, the step is reflected in the outline of the housing. For example, the outline corresponding to PC card standards can be achieved by the step.

Furthermore, the hook can be reliably engaged with the head actuator assembly. Thus, the rotation of the head actuator assembly can be reliably regulated.

Still further, when the magnetic piece is attracted to the voice coil motor, the latch member can be held in the second posture. As a result, the latch member can reliably rotate about the second shaft toward the first posture in accordance with the rotation of the latch lever. Thus, the rotation of the head actuator assembly may be reliably regulated.

Incidentally, the first and second contact pieces may extend to the height lower than the predetermined height from the second height.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A recording disk drive comprising:
a head actuator assembly configured to support a head slider, and follow a predetermined moving path when separated from a lamp member by being swung about a spindle;
a voice coil motor configured to be connected to the head actuator assembly;
a housing configured to house at least the head slider, the head actuator assembly, and the voice coil motor, and define a flat surface for receiving the voice coil motor;
a first step configured to be connected to one end of the flat surface and define a stepped surface, the stepped surface expanding parallel to the flat surface at a predetermined height from the flat surface;
a latch lever configured to be rotatably supported by a first shaft, at least part of the latch lever facing the stepped surface;
a latch member configured to be rotatably supported by a second shaft distant from the first shaft by a first distance, and rotate between a first posture where the latch member enters the moving path of the head actuator assembly and a second posture where the latch member retreats from the moving path of the head actuator assembly;
a first contact piece formed on the latch member at a position distant from the first shaft by a second distance shorter than the first distance, the first contact piece configured to cause the latch member to rotate about the second shaft toward the first posture by contact with the latch lever rotating about the first shaft in a first direction; and
a second contact piece formed on the latch member at a position distant from the first shaft by a third distance longer than the first distance, the second contact piece configured to cause the latch member to rotate about the second shaft toward the first posture by contact with the latch lever rotating about the first shaft in a second direction, and be received by the first step in the first posture of the latch member.

2. The recording disk drive of claim 1, wherein
the latch lever is configured to expand at a first height higher than the predetermined height from the flat surface,
the latch member is configured to expand at a second height higher than the first height from the flat surface, and
the first contact piece and the second contact piece are configured to extend to a height lower than the predetermined height from the second height.

3. The recording disk drive of claim 1, wherein the housing is configured to define the flat surface and the first step on a first surface of a base formed of a metal plate.

4. The recording disk drive of claim 3, wherein a second step, which reflects shape of the first step, is formed on a second surface of the base opposite the first surface, the second step being located opposite the first step.

5. The recording disk drive of claim 1, wherein the latch member comprises
a swing piece configured to extend from the second shaft toward the first shaft, and
a hook at an end of the swing piece, the hook configured to have a thickness larger than a thickness of the swing piece in an axial direction of the second shaft, and caught by the head actuator assembly at the latch member in the first posture.

6. The recording disk drive of claim 1, further comprising a magnetic piece on the latch member, the magnetic piece configured to be attracted by a magnetic force applied from the voice coil motor.

7. A latch device comprising:
a base configured to house at least a head slider, a head actuator assembly, and a voice coil motor, and define a flat surface for receiving the voice coil motor;
a step configured to be connected to one end of the flat surface and define a stepped surface, the stepped surface expanding parallel to the flat surface at a predetermined height from the flat surface;
a latch lever configured to be rotatably supported by a first shaft, at least part of the latch lever facing the stepped surface;
a latch member configured to be rotatably supported by a second shaft distant from the first shaft by a first distance, and rotate between a first posture where the latch member enters a moving path of the head actuator assembly and a second posture where the latch member retreats from the moving path of the head actuator assembly;
a first contact piece formed on the latch member at a position distant from the first shaft by a second distance shorter than the first distance, the first contact piece configured to cause the latch member to rotate about the second shaft toward the first posture by contact with the latch lever rotating about the first shaft in a first direction; and
a second contact piece formed on the latch member at a position distant from the first shaft by a third distance longer than the first distance, the second contact piece configured to cause the latch member to rotate about the second shaft toward the first posture by contact with the latch lever rotating about the first shaft in a second direction, and be received by the step in the first posture of the latch member.

8. The latch device of claim 7, wherein
the latch lever is configured to expand at a first height higher than the predetermined height from the flat surface,
the latch member is configured to expand at a second height higher than the first height from the flat surface, and
the first contact piece and the second contact piece are configured to extend to a height lower than the predetermined height from the second height.

9. The latch device of claim 7, further comprising:
a swing piece configured to extend from the second shaft toward the first shaft, and
a hook configured at an end of the swing piece, the hook configured to have a thickness larger than a thickness of the swing piece in an axial direction of the second shaft, and caught by the head actuator assembly at the latch member in the first posture.

10. The latch device of claim 7, further comprising a magnetic piece on the latch member, the magnetic piece configured to be attracted by a magnetic force applied from the voice coil motor.
